(19) United States
(12) Patent Application Publication
(10) Pub. No.: US 2016/0290784 A1
(43) Pub. Date: Oct. 6, 2016

(54) INTERFEROMETRIC METHOD AND APPARATUS FOR SPATIO-TEMPORAL OPTICAL COHERENCE MODULATION

(71) Applicant: AM2M SP Z O.O. SP KOM, Torun (PL)

(72) Inventors: Maciej Wojtkowski, Torun (PL); Maciej Nowakowski, Leszno (PL); Dawid Borycki, Torun (PL)

(21) Appl. No.: 15/035,427

(22) PCT Filed: Nov. 13, 2013
(86) PCT No.: PCT/EP13/73710

§ 371 Date: May 9, 2016

(51) Int. Cl. G01B 9/02

(52) U.S. Cl. CPC G01B 9/02024; G01B 9/02091; G01B 9/0201

(57) ABSTRACT

The invention relates to applications of optical interference. It is already known to reduce speckle contrast by introducing arbitrary phase shifts in the reference light beam. According to the invention, such phase shifts are not introduced arbitrarily, but systematically whereby the phase changes are synchronised with the acquisition time intervals in such a way that interference fringes can be washed out in selected regions of the beam diameter maintaining high contrast of interference fringes in the desired regions at the same time. This technique can be used for enhancing the lateral resolution in imaging techniques and the bandwidth in optical communications.

The invention related to a method of and apparatus for manipulating the interference fringe contrast in a beam of light.

Numerous optical applications utilising interference effects are widely known in the art. Among these applications, optical imaging and optical communications play important roles. Normally, a maximum of interference contrast is desired in order to achieve an optimal signal-to-noise ratio.

The invention has found, however, that improvements can also be achieved by reducing the interference contrast in a targeted manner. It is based on the idea of tailoring the interference contrast of portions of a beam of light in an interferometric setup by introducing phase shifts and synchronising these phase shifts with the detection process.

As opposed to speckle reduction techniques, where phase shifts are introduced in a rather arbitrary manner, the invention does this in a targeted manner to tailor the interference contrast as desired. For optical imaging, the sensitive cross-section can be reduced so that the lateral resolution of the imaging system can be increased. In communications, more than one bit of information can be encoded in the cross-section of a monochromatic optical beam.

The invention achieves these improvements with the method of claim 1 and the apparatus of claim 9. The sub-claims define further improvements of the invention.

The term “light” according to the invention means electromagnetic radiation with vacuum wavelengths in the range of 300 nm to 1,500 nm, preferably in the range of 650 nm to 1,300 nm. Light generation according to the invention can be performed, in particular, a laser, laser diode or a superluminescent diode, which may serve as light sources according to the invention.

A processing beam is a beam which is used for processing steps, e.g. which is used for illuminating a sample in imaging applications or which carries data in communications applications. A reference beam is a beam which is superimposed with the processing beam to generate interference fringes used for further evaluation. It is possible that a reference beam is also used for processing steps.

As far as the invention involves a beam splitting step or beam splitting means, this does not preclude further beam splitting steps or beam splitting means, as may be useful for the particular application. So there may be further optical paths next to the optical processing path and the optical reference path, and said paths may be subdivided in sub-paths. The same applies to other processing steps or means such as beam formation, signal generation etc. Beam splitting means may consist of bulk optics or an optical coupler.

An interferometric signal from two beams is a signal which depends on the degree of coherence between these two beams. The signal generation from two beams according to the invention can be performed in various ways. In particular, it can be done by superimposing the two beams optically so that a superimposed beam is formed, which beam is directed to a photodetector. The photodetector may convert the light intensity of the superimposed beam into an electric signal. In this case, the sensor means according to the invention comprises at least a single photodetector. Alternatively, the intensities of both beams may be measured separately, e.g. with one photodetector for each of both beams, and the signals correlated so that they depend on the degree of coherence of the two beams (cf. Hanbury Brown Twiss, Nature 177, 27 (1956)). In this case, the sensor means according to the invention comprises at least two photodetectors and one correlation means. The requirement that the measured signal depends on the degree of coherence of the two beams does not preclude that it may also depend on other parameters. However, it is preferably measured or processed in such a way that it is an unambiguous representation of the effective degree of coherence. In the definition of such effective degree of coherence the process of detection and its time constant is included. It is not necessary that all portions of each beam contribute to the generated interferometric signal. It is, in fact, preferred that only portions of the beams, including the reference beam, are used.

Shifting the phase of a portion of the processing or the reference beam does not exclude the possibility that both beams undergo phase shifts. However, it is essential that the phase shift of a beam is effected relatively to at least one other portion of the same beam and to at least a portion of the other beam, which latter portion contributes to the generation of the interferometric signal.

Phase shifting means according to the invention are means which may apply phase shifts on at least one portion of a light beam at a predetermined point of time. For instance, spatial light modulators which may apply predetermined phase shifts on a two-dimensional array of portions of a light beam, i.e. a phase mask, when a corresponding signal is applied may serve as phase shifting means. The phase shifting means may be liquid crystal devices.

The signal generation is performed during a predetermined signal generation time interval. In case of the above photodetector measuring the intensity of the superimposed beam, the light intensity captured by the detector is integrated over a period of time to give the desired signal. A camera with a line or a two-dimensional array of photodetectors may also be used, preferably in combination with a spatial light modulator as phase shifting means. The exposure time of the camera may be the signal generation time interval. However, if a pulsed light source is used and the light pulse is shorter than the exposure time, the duration of a light pulse may be taken as signal generation time interval. In this case, the predetermined periods after which phase shiftings are performed may be taken from the commencement of the light pulse, i.e. the synchronising means would preferably synchronise the phase shifting with the light source. If, however, the exposure time of the camera or other detection system is taken as signal generation time interval, the synchronising means preferably synchronises the phase shifting with the sensor means. In the apparatus according to the invention, the predetermined periods are preferably adjustable. Similarly, but independently, the predetermined phase shifts are preferably adjustable.

The intensity of the light at the position of the detector r_{d} at one instant of time t may be expressed by the following equation:

[symbol]

I(r_{d}, t) [symbol] = [symbol] (I₁(r_{d}, t) [symbol] + [symbol] I₂(r_{d}, t) [symbol] +2\sqrt{ [symbol]I₁(r_{d}, t) [symbol] [symbol] I₂(r_{d}, t) [symbol]}Re [γ_{eff}(r₁, r₂, τ, φ^{(N)})]

with brackets < . . . > denoting time-average,

$$〈 f ( t ) 〉 = {lim}_{T \to ∞} \frac{1}{2 T} {\int }_{- T}^{T} f ( t ) d t$$

where the infinity symbol must be interpreted practically with respect to the particular detector device used (current photodetectors can resolve time periods of the order of 10⁻⁹ s, while for the present invention signal generation time intervals may range typically between 10⁻³ s and 10⁻¹ s).

And the terms <I₁(r_{d}, t)> and <I₂(r_{d}, t)> are averaged light intensities of the processing beam and the reference beam, while the third term expresses the contribution of the correlated light portions. This latter term largely depends on the real part of the effective complex degree of coherence γ_{eff}(r₁, r₂, τ, φ^{(N)}), in which r₁ is a point on the light source from which a portion of light travels through the processing path to r_{d}, r₂ is another point on the light source from which a portion of light travels through the reference path to r_{d}, τ is the time difference in time which these two portions need to travel from r₁ to r_{d} and r₂ to r_{d}, respectively, and φ^{(N)} is a set of N phase shifts introduced during the signal generation time interval.

Since the phase shifts are introduced at predetermined periods, the effective complex degree of coherence γ_{eff}(r₁, r₂, τ, φ^{(N)}) can be written as a sum

$${γ}_{eff} ( {r}_{1} , {r}_{2} , τ , {ϕ}^{( N )} ) = {\sum }_{i = 1}^{N} {γ}_{i} ( {r}_{1} , {r}_{2} , τ , {ϕ}^{( i )} )$$

in which each term corresponds to the complex degree of coherence corresponding to the phase shift φ⁽ⁱ⁾. It can be assumed that |γ₁|=|γ₂|= . . . =|γ₂|=|γ|, if only the phase of the complex degree of coherence is modulated. For I₁=I₂, |γ| corresponds to fringe visibility V. Otherwise it is proportional to V.

If, for instance, N=2 and φ⁽²⁾={0, π} with the phase shift performed at half of the signal generation time interval, the interference fringes will be washed out. The aforementioned equation may be written as:

$$\begin{matrix}{γ}_{eff} ( {r}_{1} , {r}_{2} , τ , {ϕ}^{( 2 )} ) = {γ}_{1} ( {r}_{1} , {r}_{2} , τ , 0 ) + {γ}_{2} ( {r}_{1} , {r}_{2} , τ , π ) \\ = \vert γ ( {r}_{1} , {r}_{2} , τ ) \vert ( exp [ 0 ] + exp [ i π ] )\end{matrix}$$

$$Thus , \\ Re [ {γ}_{eff} ( {r}_{1} , {r}_{2} , τ , {ϕ}^{( 2 )} ) ] = 0$$

The signal generation time interval is preferably adjustable. Preferably, one or more CMOS detectors are used for the signal generation step, and the sensor means of the invention comprises one or more CMOS detectors. If there is more than one CMOS or other detector, they may be arranged to form a one or two dimensional array. The signal generation time intervals may be identical for all detectors, and they may be adjustable jointly or separately.

If the intensities of both beams are measured separately, the integration over the signal generation time interval is performed in the correlation means.

Advantageously, the method according to the invention further comprises the steps of performing a second phase shifting for an associated portion of the processing beam or the reference beam about a second predetermined phase within the signal generation time interval. Analogously, the synchronising means according to the invention is further arranged for triggering a second phase shifting for an associated portion of the processing beam or the reference beam about a second predetermined phase shift within the signal generation time interval. Such second phase shifting may be performed at the same location as the first phase shifting. In the apparatus according to the invention, it is preferably performed by the same phase shifting means, e.g. spatial light modulator, preferably based on liquid crystal cells. Such separate phase shifting means may be arranged in series, in which case they are preferably transmissive for the light beam. But they likewise may be arranged in parallel, in which case they are preferably reflective for the light beam. In this case, the beam for which the phase shifting is performed is further split so that separate portions of the beam impinge on separate phase shifting means. However, it is also possible that, if the first phase shifting has been performed upon with reference beam, the second may be performed upon the processing beam and vice versa. The phrase “associated” in this regard means that the second phase shift also influences the interferometric signal. If the second phase shifting is performed at the same location as the first phase shifting, it takes place after a second predetermined period within the signal generation time interval, which may be shorter or longer than the first predetermined period. Preferably, the second phase shifting counteracts the first phase shifting, e.g. if the first phase shift adds an amount between 0 and π, the second adds an amount between −π and 0, whereas the absolute amounts are preferably the same. This second phase shifting at the same location may be particularly advantageous if the phase shifting is performed with liquid crystal devices where the inertia of the liquid crystal molecules is exploited. Alternatively the second phase shifting may be performed at another location. In this case, it may be performed simultaneously with the first phase shifting or likewise after a longer or shorter second predetermined period.

It is also advantageous if the method according to the invention comprises the additional steps of generating a plurality of interferometric signals from the processing beam and the reference beam, during predetermined signal generation time intervals, whereas each generation time interval is associated with one of the signals, and performing said first phase shifting, and optionally second phase shifting, separately for each portion of a plurality of portions of the processing beam and/or the reference beam about predetermined first, and optionally second, phase shifts after first, and optionally second, predetermined portions of the signal generation time intervals, whereas each of the phase shifted beam portions is associated with one of the interferometric signals. Analogously, the sensor means of the apparatus is arranged for generating a plurality of interferometric signals from the processing beam and the reference beam during predetermined signal generation time intervals, whereas each generation time interval is associated with one of the signals, and the phase shifting means is arranged for shifting the phases separately for each portion of a plurality of portions of the processing beam and/or the reference beam about predetermined first, and optionally second, phase shifts after first, and optionally second, predetermined portions of the signal generation time intervals, whereas each of the phase shifted beam portions is associated with one of the interferometric signals. In this case, the beam diameter is dissolved into various portions for which the phase shifting is performed separately. While these portions may overlap, they are preferably disjoint. The portions may encompass the entire beam diameter or a part of it. The phase shifting is preferably performed with a spatial light modulator as phase shifting means containing a two dimensional array of cells, each of which applying a separate first, and optionally second, predetermined phase shift. This allows applying phase masks to the beam for which the phase shifting is performed. It is also preferred that all generation time intervals have the same lengths. Additionally or alternatively, all generation time intervals may commence at the same moment in time. Similarly, the first predetermined periods may all have identical lengths. Additionally or alternatively, the second predetermined periods may all have identical lengths. The phase shiftings may be performed for all of the portions from which interferometric signals are generated or for a selection from them. The phase shiftings are preferably all performed on either the reference beam or the processing beam. In imaging application, it may be advantageous to perform the phase shifting on the processing beam in order to deliver the phase shifted portion of the beam to the object. However, it is not excluded to perform some phase shiftings on the processing beam and some on the reference beam. For instance, if second phase shifts are also performed, they may take place in the processing beam while the first phase shifts take place in the reference beam and vice versa. It is also not excluded that some of the first phase shifts are performed for the reference beam and some other first phase shifts for the processing beam. If second phase shiftings are performed, all or some of them may counteract the first phase shiftings.

Advantageously, the plurality of portions with which phase shiftings are performed comprise a set of portions which are at least partially disjoint, whereas the disjoint regions are distributed along a circumference. The circumference is preferably closed, i.e. each section of the circumference is covered by a portion with which at least one phase shifting is performed. If, in these cases, adjustment is made in such a way that the circumference encompasses a region of interest in imaging, the lateral resolution for that region of interest can be significantly improved. Preferably, there is no phase shifting during the entire signal generation time interval(s) for the beam portion surrounded by the circumference. This will maintain highest fringe contrast within the circumference. For instance, a phase mask may be applied initially which has first identical values, e.g. π, for the region surrounded by the circumference and a first set of portions covering the circumference, and different second identical values, e.g. 0, for a different set of portions covering the circumference. After the first predetermined period, e.g. half of the signal generation time interval, the first phase shifting is performed by applying another phase mask which has said first identical values for the region surrounded by the circumference and said second set of portions covering the circumference, but said second identical values for said first set of portions covering the circumference. Each set may consist of a single or more portions. Preferably, the sets are selected in such a way that the portions of both sets cover the entire circumference.

If this modality is combined with using a second phase shifting counteracting the first phase shifting, phase masks used for the first and second phase shifting should be selected in such a way that the counteraction is applied to the region of interest and not to the portions covering the circumference. Utilising the inertia of the liquid crystal molecules, there will be only little wash-out in the region of interest surrounded by the circumference but full-wash outs at the circumference.

If a sample to be investigated is placed into the optical processing path, the method according to the invention may be utilised for imaging. Correspondingly, the apparatus according to the invention advantageously comprises sample mounting means located in the optical processing path. In this case, it is further advantageous for the apparatus according to the invention if it comprises scanning means located in the processing path arranged for scanning the processing beam over a sample position in said sample mounting means. The scanning means can be a line scanner an xy scanner, to scan the processing beam across the sample for 2D or 3D imaging. Moreover, an objective lens can be placed in front of the object to optimise the intensity of the light for the image formation both in the method and the apparatus of the invention. The sample can be imaged with transmitted or reflected or otherwise backscattered light.

For communications applications, it is advantageous for the method said first phase shifting is performed for the plurality of portions of the processing beam and/or the reference beam in dependence of digital data. Analogously, the phase shifting means according to the invention is advantageously arranged for shifting the phases separately for each portion of said plurality of portions of the processing beam and/or the reference beam in dependence of digital data. Digital data are a set of bits, each of which representing one of the state on/1 or off/0. Usually, a beam of light may carry only one bit by switching the beam on and off. However, the invention allows partitioning the beam into several portions each of which representing one bit, e.g. phase shifted or not shifted. One of these portions may be a matrix portion surrounding a set of separated data portions, each data portion being associated with one bit. While the phase shifting for the matrix portion is adjusted in such a way that a full wash-out is obtained, the phase shiftings for the data portions are adjusted in dependence of the bits to be communicated. If, for instance, five bits with the information 01100 shall be communicated at once, the phase shiftings for the first, fourth and fifth data portions may be adjusted to cause a full wash-out, whereas no phase shiftings are performed for the second and third data portions so that full contrast is obtained for these portions. In this way the bandwidth of the beam of light used as a communications line is multiplied by five.

Advantageously, said beam splitting and first, and/or optionally second, said phase shifting are performed as one step. Analogously, the beam splitting means of the apparatus according to the invention is further arranged for arranged for shifting the phase of a portion of the processing beam or the reference beam. In this case, it assumes the function separate phase shifting means so that a separate device as a phase shifting means may be omitted, unless a second phase shifting at another location is desired. These modifications allow simplifying the setup for utilising the invention.

In optical communications applications, it is advantageous to recombine the processing beam and the reference beam after said first, and optionally second, phase shifting, to direct the recombined beam into an optical communications path before generating said at least one interferometric signal. Analogously, the apparatus according to the invention advantageously comprises recombining means arranged for recombining the processing beam and the reference beam and for directing the recombined beam into an optical communications path. The signal generation is thus performed on the recombined light beam after it passed the optical communications path. This simplifies the setup in that only one optical path is used for the communications line which may range over a long distance. In the method according to the invention, it is in this case further advantageous to send a synchronising light beam through said optical communications path. Analogously, the apparatus according to the invention advantageously further comprises synchronising signal generation means, e.g. a pulsed laser, arranged for sending a synchronising light beam through said optical communications path. This further simplifies the setup in that only one optical path is necessary to transmit both the communications light beam and a synchronising light beam. The synchronisation light beam may be pulsed and/or otherwise modulated, e.g. by change of polarisation, to communicate a synchronising signal. A synchronising signal may represent the commencement of the signal generation time interval. It may additionally represent one or more predetermined periods after which phase shifts are performed. It may be sent in the same or opposite direction as the recombined processing and reference beam. The optical communications path preferable comprises, and more preferably consists of, a multimode fibre.

The generated beam of light may be monochromatic, or broadband radiation. If, in the latter case, the phase shifting step(s) or means feature dispersion, e.g. in case of a periodic cell structure of a spatial light modulator used as phase shifting means, they are preferably performed, or arranged to operate, in the 0^{th} diffraction order. However, it is also possible to work in the 1^{st} order if the radiation as a relatively narrow bandwidth, e.g. not broader than 20 nm, preferably 10 nm vacuum wavelengths. If broadband radiation is used, the method according to the invention advantageously involves a step of spectrally decomposing the light so that signal generation is performed separately for a plurality of spectral components. Analogously, in the apparatus according to the invention, the sensor means is preferably further arranged for spectrally decomposing the light and generating a plurality of interferometric signals from separate spectral components. In this way, the invention may be utilised for spectrally sensitive applications, e.g. spectral optical coherence tomography.

If it is desired to suppress effects caused by the inertia of the phase shifting step(s) or, respectively, the phase shifting means, the signal generation time interval can be temporarily interrupted. This can be done by temporarily blocking the light used for the signal generation, e.g. with the shutter of a camera used as sensor means. The duration of such interruption is preferably set to cover the entire first, and optionally second, phase shifting process. In this way it is possible to perform the invention with well-defined first, and optionally second, phase shifts only, e.g. exactly π without transition values.

Some exemplifying embodiments of the invention will now be explained in greater detail with reference to the following drawings:

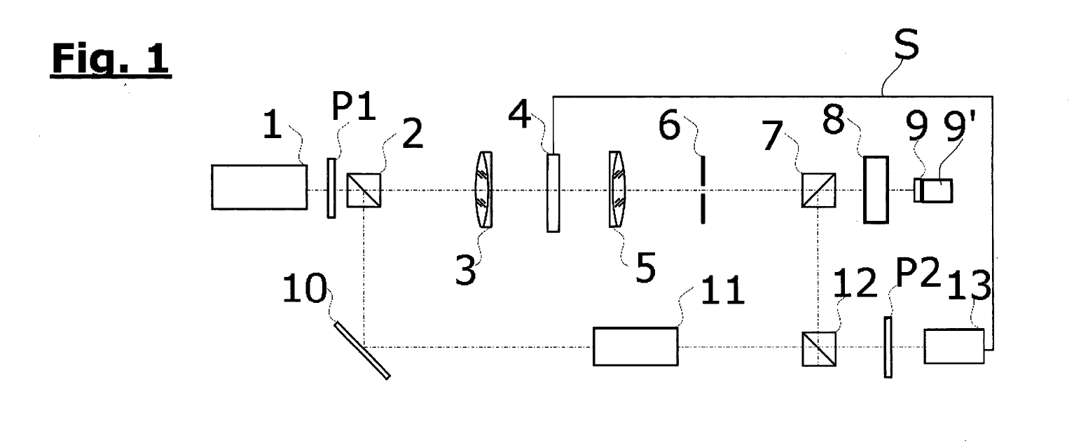

FIG. 1 is a schematic view of a first setup employing the invention for imaging;

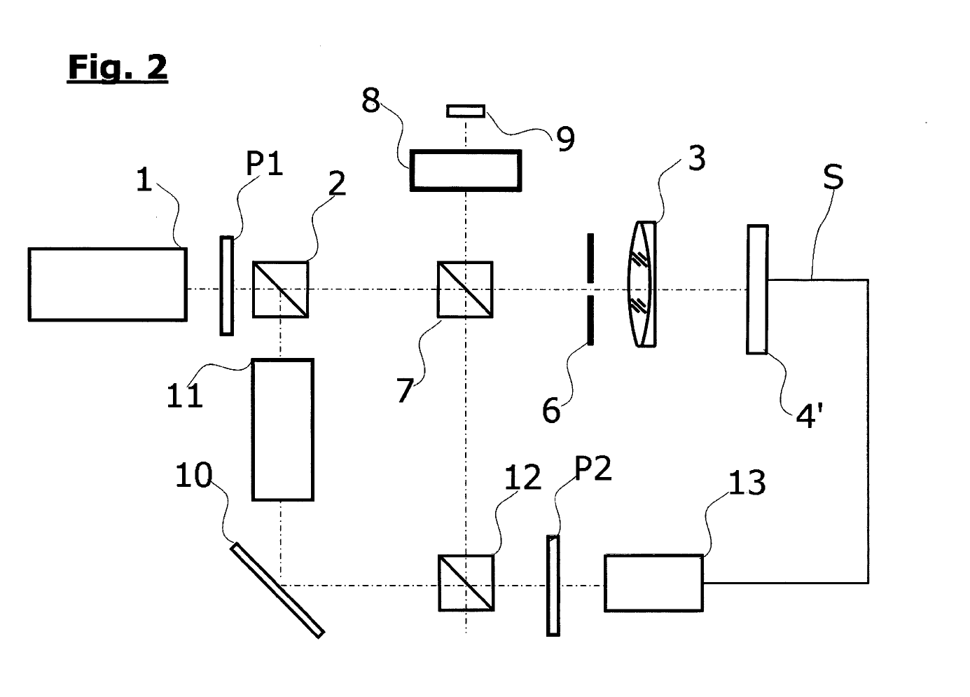

FIG. 2 is a schematic view of a second setup employing the invention for imaging;

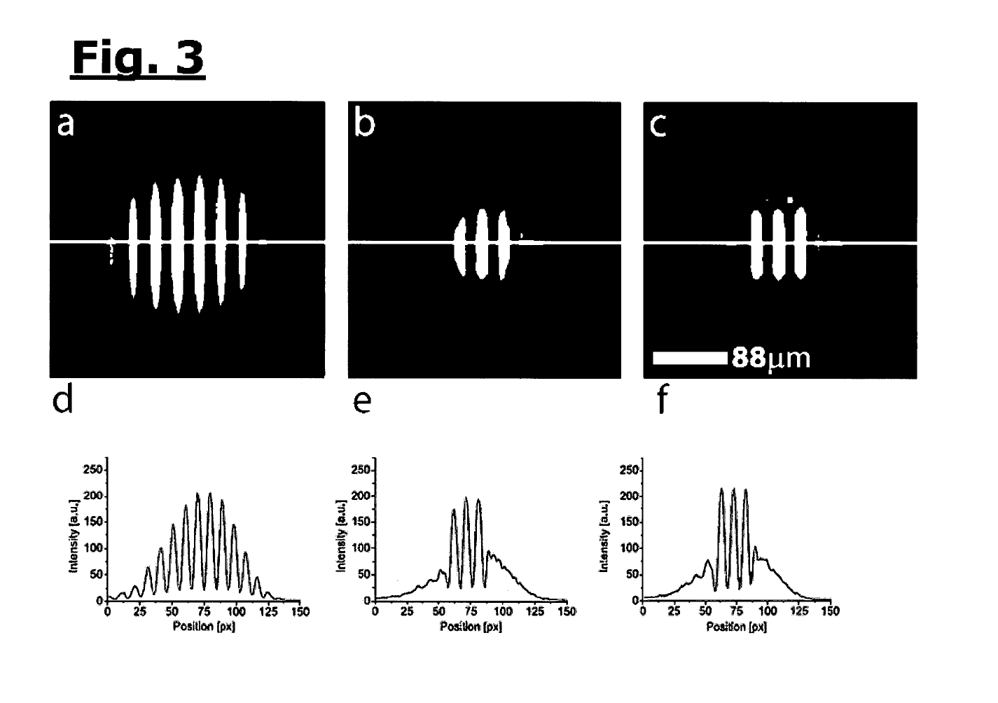

FIG. 3 is a first selection of images acquired with a setup like that of FIG. 2 and corresponding intensity diagrams;

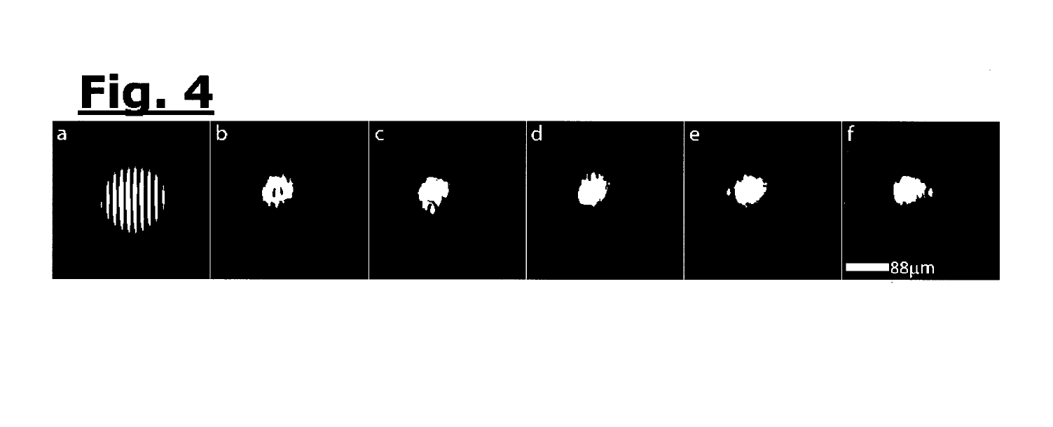

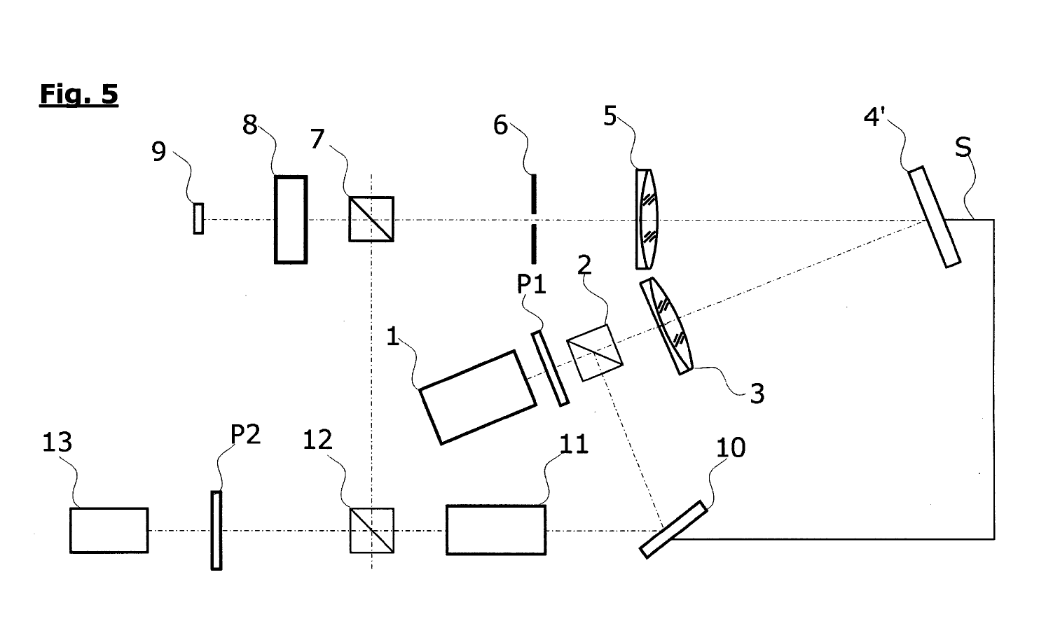

FIG. 4 is a second selection of images acquitted with a setup like that of FIG. 2;

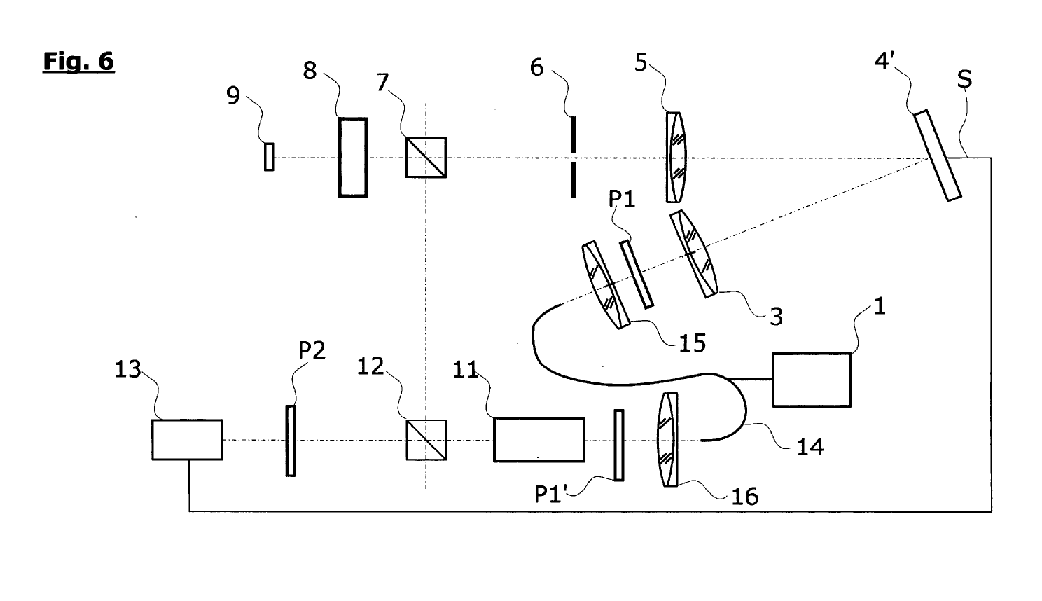

FIG. 5 is a schematic view of a third setup employing the invention for imaging;

FIG. 6 is a schematic view of a fourth setup employing the invention for imaging;

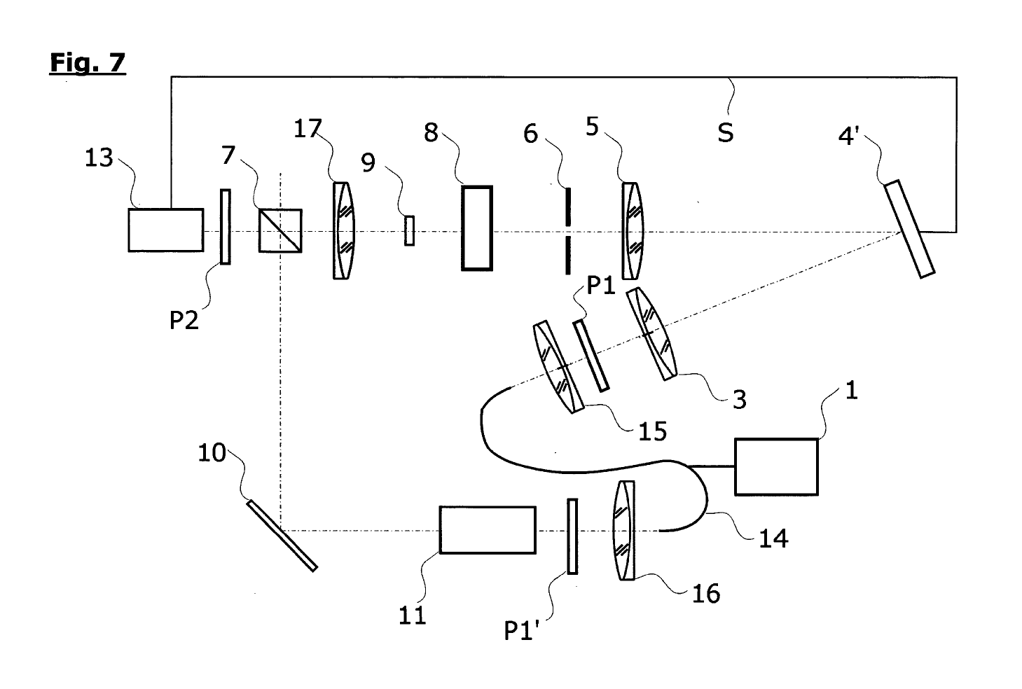

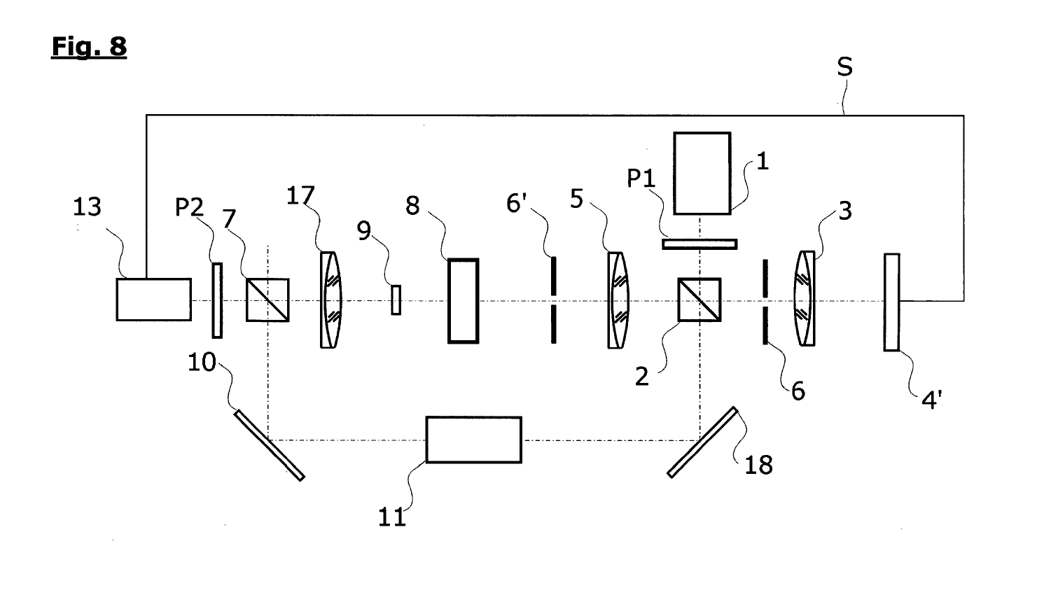

FIG. 7 is a schematic view of a fifth setup employing the invention for imaging;

FIG. 8 is a schematic view of a sixth setup employing the invention for imaging;

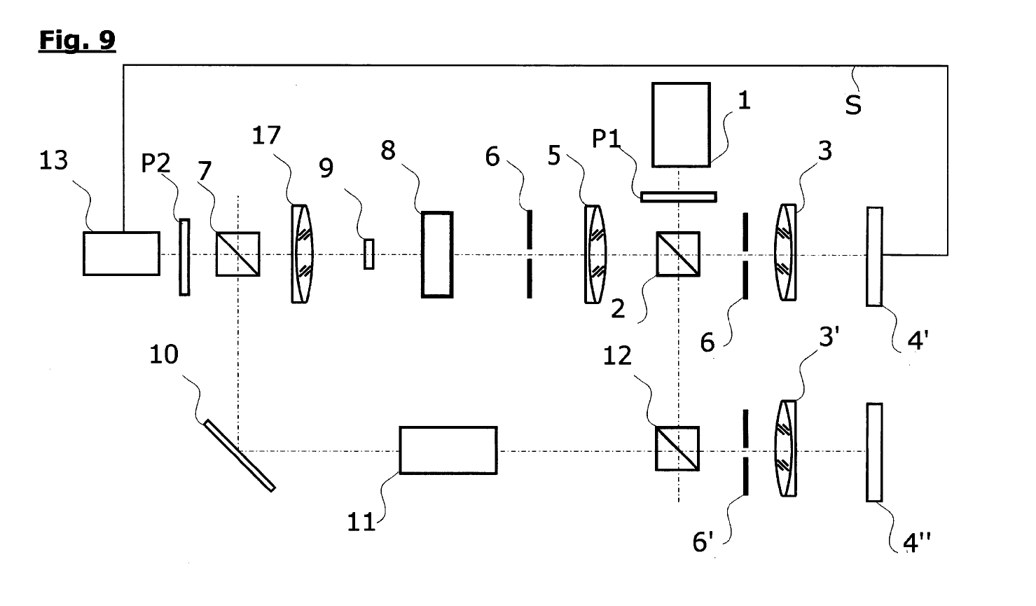

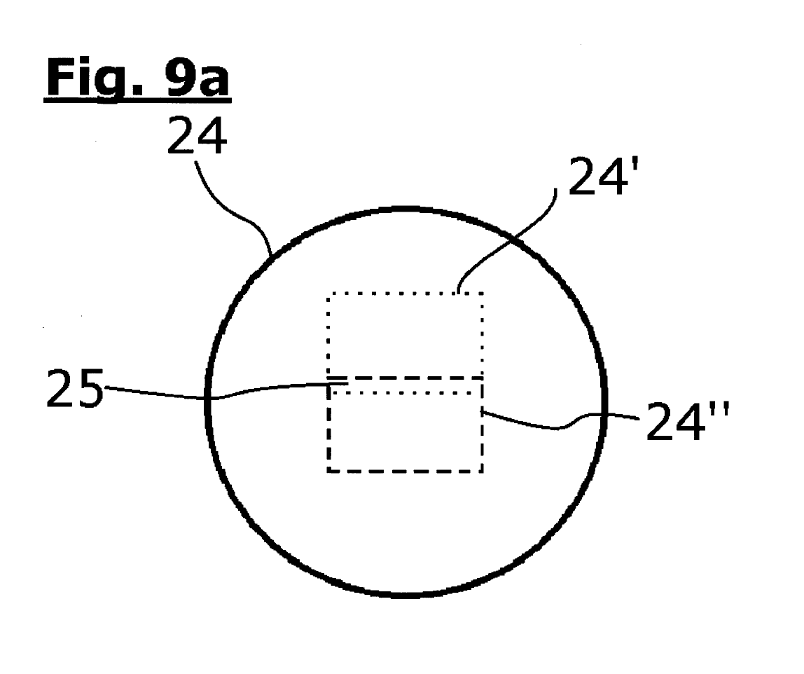

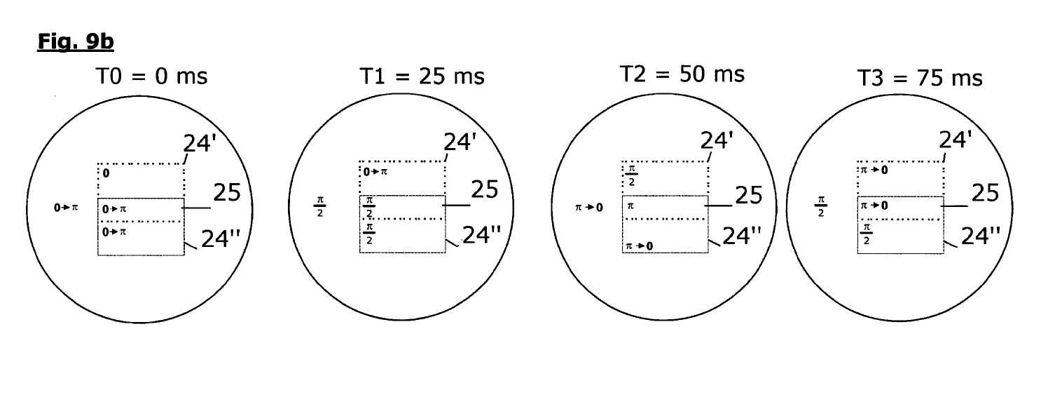

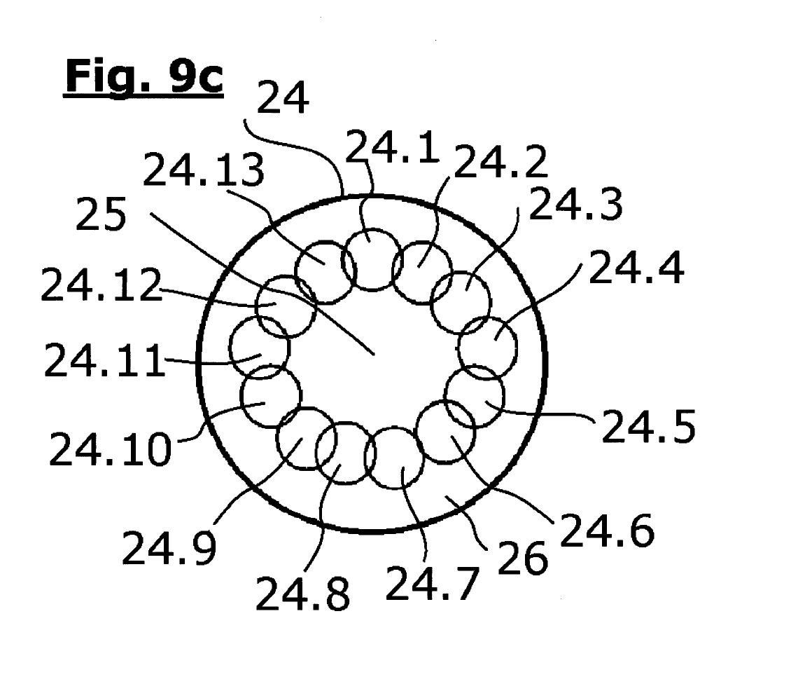

FIG. 9 is a schematic view of a seventh setup employing the invention for imaging;

FIG. 9a is a schematic view showing the performance of various phase shifts;

FIG. 9b is another schematic view showing the performance of various phase shifts;

FIG. 9c is a further schematic view showing the performance of various phase shifts;

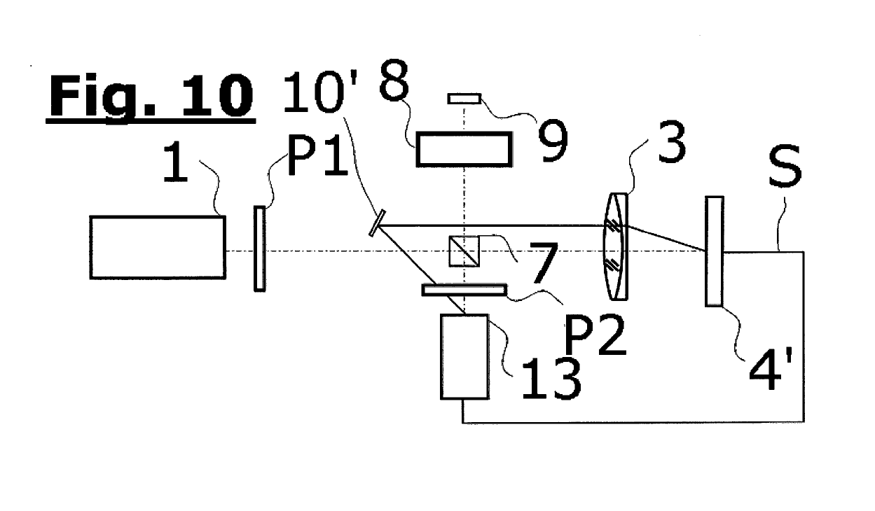

FIG. 10 is a schematic view of an eighth setup employing the invention for imaging;

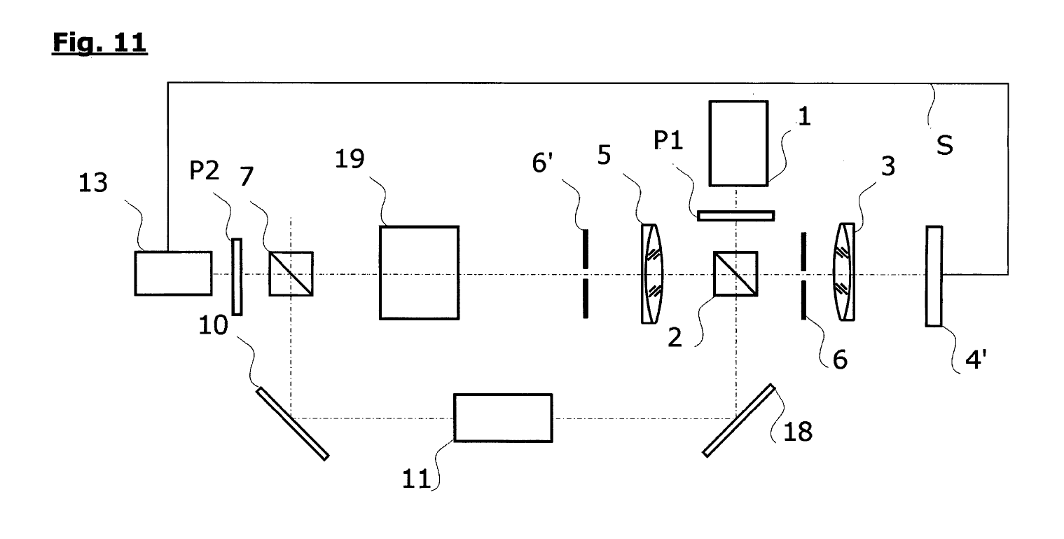

FIG. 11 is a schematic view of a ninth setup employing the invention for communications;

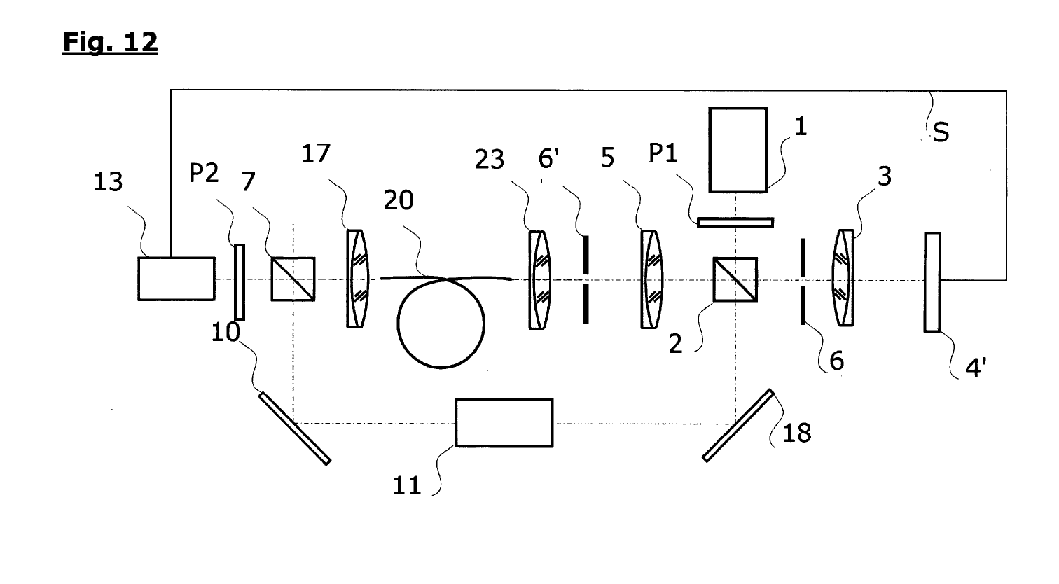

FIG. 12 is a schematic view of a tenth setup employing the invention for communications;

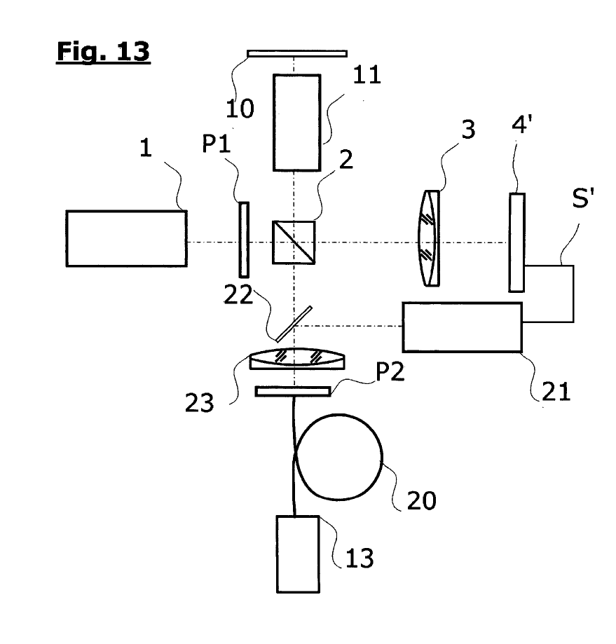

FIG. 13 is a schematic view of an eleventh setup employing the invention for communications;

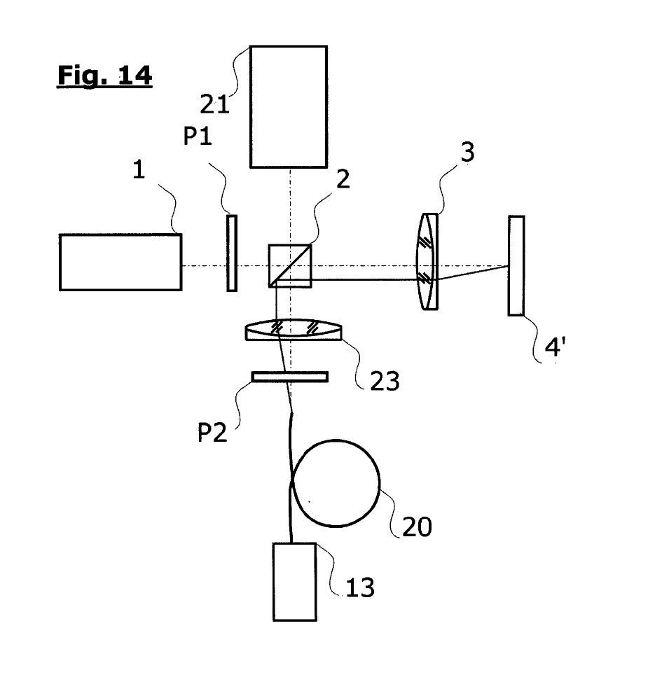

FIG. 14 is a schematic view of a twelfth setup employing the invention for imaging.

FIG. 1 shows the main components of a setup for employing the invention in imaging. The setup is based on a Mach-Zehnder interferometer configuration with bulk optics, which is useful, however not obligatory for employing the invention. A spatially coherent beam of light is generated by a light source 1, e.g. a laser diode emitting light at a vacuum wavelength of 820 nm. A beam splitter 2 splits the light beam into a processing beam and a reference beam. The processing beam is directed into an optical processing path, while the reference beam is directed into an optical reference path.

In the optical processing path, a lens system 3 focuses the processing beam on a phase shifting means 4 arranged for shifting the phase of a portion of the processing beam. For instance, lens system 3 may be arranged in such a way that the focused spot size at the plane of the active region of phase shifting means 4 is equal to 288 μm. Phase shifting means 4 is transmissive in this example and may be a spatial light modulator active region of more than 1,000×1,000 pixels with a pitch size 8 μm (e.g. Holoeye Pluto NIR II, 1920×1080 pixels with 8 μm pitch size, cf. S. Osten, S. Kruger, and A. Hermeschmidt, “New hdtv (1920×1080) phase-only slm,” in “Adaptive Optics for Industry and Medicine”, C. Dainty, ed., Imperial College Press, London, 2007). So while the entire beam diameter hits on the active region, a single pixel may shift the phase of a portion of not more than 8 μm×8 μm of the processing beam. The thus manipulated beam propagates to a further lens system 5 arranged for collimating the beam. As the fragmentation of the active region into narrow pixels acts as a grating splitting the beam into several orders, a pinhole 6 is used to cut out the order desired for measurements. For instance, the 0^{th} order may be used to preserve as much intensity as possible, but the 1^{st} order may be better for excluding disturbing effects. If the setup shall work with the first order, the plane of the active area should be beveled slightly with respect of the axis of the light beam.

The thus processed light beam propagates to another beam splitter 7, from which one portion enters an optical probing path which is part of the optical processing path in this example. In the probing path, an xy scanner 8 scans the beam over a sample 9 mounted on a sample mounting means 9′, from where it is reflected back to said splitter 7 and then sent further through the optical processing path to further beam splitter 12 for recombination with the reference beam, which in the meantime has passed a mirror 10 and an optical delay line 11. The optical delay line 11 is adjusted in such a manner that an interferometric signal is generated by the superimposed beams. For imaging of sample 9, it should be adjusted in such a way that the optical path length of the light travelling through the optical processing path including the probing path is similar to the optical path length for the light travelling trough the reference path.

The recombined light beam is analyzed by a detector 13 which may be a CMOS or CCD camera with an objective lens system and a detector chip comprising more than 1,000×1,000 pixels, e.g. Basler CMOS camera acA2040-180 km camera with 2,048×2,048 pixels of 5.5 μm×5.5 μm working with a frame rate of 180 fps. So an image may be acquired within 6 ms, but longer acquisition time intervals may be employed.

If the shifting means 4 is birefringent, e.g. if it works with liquid crystals (LC), a polariser P1 may be inserted before lens system 3 to suppress effects of birefringence. In case of an LC phase shifting means like the aforementioned Holoeye device, the polarisation direction of the light beam shall be brought in parallel with the LC director axis. In this case, one obtains pure phase modulation, i.e. the above condition Re[γ( . . . )]=0 is fulfilled.

Correspondingly, a second polariser P2 with the same orientation may be inserted before the detector 13 to block disturbing light with other polarisation directions.

The phase shifting means 4 is connected to the detector 13 by a synchronisation line S. During the acquisition time interval of the detector 13, the phase shifting means may shift the phase for one or several pixels, i.e. portions of the processing beam, at about a predetermined phase shift at a predetermined portion of the signal generation time interval. For instance, a phase shift of 0 may be applied for all pixels at the commencement of the acquisition time interval, but the phase shifts for all pixels except for a few in the center are changed from 0 to π after half of the acquisition time interval. The synchronisation line S ensures that this timing condition is exactly met.

For instance, the acquisition time interval of the detector may be set to 100 ms or 200 ms and a phase shift from 0 to n may be triggered after 50 ms or 100 ms, respectively. For practical reasons, however, it may be practical to account for response time of the phase shifting means. In case of a liquid crystal device, the molecules need some ms for reorientation. Assuming this response time to be around 10 ms, the phase shift should be triggered at 45 ms or 95 ms, respectively. The response time may be significantly reduced by using other than liquid crystal modulators device, e.g. to the ps range with micro-electro-mechanical systems (e.g. from Boston Micromachines Corporation). The acquisition time intervals may be reduced accordingly.

FIG. 2 shows how a reflective phase shifting means 4′, e.g. Holoeye Pluto NIR II, 1920×1080 pixels with 8μm pitch size, can be used instead of the transmissive phase shifting means 4 of FIG. 1. Apart from that, the setup is also based on a Mach-Zehnder interferometer configuration and the bulk components have the same functions as in FIG. 1. For imaging of sample 9, the optical delay line 11 should be adjusted in such a way that the optical path length of the light travelling through the optical processing path, including the probing path and the path in which the phase shifting means 4′ is placed, is similar to the optical path length for the light travelling trough the reference path.

The effect of such phase shifting is illustrated in FIG. 3, where the upper three pictures a, b and c show the images acquired by the camera in a setup like that of FIG. 2 and the lower three pictures d, e and f show corresponding intensity profiles along the central horizontal white lines shown in pictures a, b and c, respectively. For better illustration, the effects of a sample 9 were excluded for the generation of these pictures by adjusting the optical delay line 11 so that the optical lengths of the optical reference path corresponds to the optical length of the optical processing path without the optical probing path. In the measurement corresponding to pictures a and d, there was no phase shift during the acquisition time interval. Pictures b and e, however, where generated with a phase shift of n applied after half of the acquisition time interval to all pixels except a plurality of pixels centered in a circle around the optical axis of the beam. It can be seen that the interference has been washed out for all pixels outside this circle. Similarly, a square instead of a circle was used for the measurement with which pictures c and f were generated.

For imaging techniques using only the interferometric signal, e.g. optical coherence tomography (OCT), the portions of the beam for which the interference is washed out do not contribute to the probing signal. For these techniques, the portion of the beam diameter which is relevant for the measurement can be significantly reduced in a desired manner by the above described phase shifting, so that the lateral resolution may be increased correspondingly.

FIG. 4 shows example pictures in which all but very tiny portions extending over four pixels on the active region of the phase shifting means have been washed out. Again, picture a corresponds to a measurement without phase shifting. In picture b, the entire beam diameter except for a tiny portion in the center has been washed out. This tiny region is shifted downwards, upwards, to the left and to the right in pictures b, c, d, e and f, respectively. This shows the extent to which the invention increases the lateral resolution of imaging techniques employing interference.

Of course, the five tiny regions shown in pictures b through f of FIG. 4 may be manipulated separately. This can be utilised for increasing the bandwidth in optical communications. With the five regions shown a fivefold increase is achieved, i.e. a single beam may communicate five bits simultaneously instead of a single one. Each of the tiny region is used as a data portion, while the surrounding portion forms a matrix portion separating the data portions. The left data portion may represent the first bit, the top data portion the second, the central data portion the third, the bottom data portion the fourth and the right data portion the fifth. In this case, picture b would represent the bit sequence 00100, picture c would be 00010, d 01000, e 10000 and f 00001. As each of the data portions may be switched on/off independently, all bit sequences from 00000 to 11111 may be communicated.

The skilled person will note that the setup may be modified in various ways. For example, the light from light source 1 may be coupled into fibre optics and collimated by an objective before the polarisation. The beam splitter 7 may be replaced by an optical circulator. The xy scanner 8 may be combined with microscope optics for focusing the beam on the sample 9. A neutral density filter may be placed in the optical reference path to adjust the intensity of the reference light beam in order to obtain a good signal-to-noise ratio. The optical delay line 11 may or may not be adjustable, and it may be static or dynamic, depending on the imaging technique employed. The detector 13 may be a single pixel detector. The synchronisation line S may or may not be a wireless connection.

FIG. 5 shows a similar setup as FIG. 4, again based on a Mach-Zehnder interferometer configuration with bulk optics, with angled illumination of the phase shifting means 4′.

The setup shown in FIG. 6 is a variation of that of FIG. 5 in that the bulk beam splitter 2 of FIG. 5 has been replaced by fibre optics 14 coupled directly to light source 1. Additional lens systems 15, 16 are placed in front of the exit ports of said fibre optics 14 for collimating the beams. As polarisation can be performed in open air only, a third polariser P1′ is needed to at one of the output ports in case the phase shifting means requires polarised light.

FIG. 7 shows a setup which is a variation of that of FIG. 6 in which the light transmitted by sample 9 is used for imaging. An additional lens system 17 is needed to collimate the light emerging from the sample 9.

Similarly, FIG. 8 shows a setup for transmissive illumination of the sample 9, whereby bulk optics is used. An additional mirror 18 is used for the optical reference path. An additional pinhole 6′ is inserted for blocking disturbing light reflections.

FIG. 9 shows a variation of the setup shown in FIG. 8, where an additional reflective phase shifting means 4″ is used, together with another lens system 3′ for focusing and a pinhole 6′ for blocking unwanted diffraction orders. FIG. 9a shows an example of how the two phase shifting means 4′ and 4″, which may be spatial light modulators, may cooperate. At the beginning of the signal generation time interval, phase shifting means 4′ applies a default phase mask with phase shifts π for the portions encompassed by dotted rectangle 24′, while for all other portions the phase shifts are 0. Likewise, the phase mask introduced by phase shifting means 4″ is 0 for all portions. After half of the signal generation time interval, the phase mask introduced by phase shifting means 4′ is switched to 0 for all portions, while at the same instant phase shifting means 4″ is switched to introduce a phase mask with phase shifts for all portions encompassed by dashed rectangle 24″. As a result, the phase shifts for the region of interest 25 covered by both rectangles 24′ and 24″ remains the same, so highest fringe contrast is obtained for this region while wash-outs are obtained at the circumference, i.e. the disjoint portions of rectangles 24′ and 24″. The size of this region of interest 25 is not diffraction limited as the rectangles 24′ and 24″ may be sufficiently large to bypass any diffraction limit, while the overlapping region 25 may be significantly smaller. The circumference can be closed in that the beam portions outside both rectangles 24′ and 24″ are included in the phase shifting, e.g. in that the phase mask introduced by phase shifting means 24″ comprises phase shifts of π for that outside region.

The aforementioned effect can also be achieved with a single phase shifting means 4 or 4′ which is shown in detail in FIG. 9b. In a typical liquid crystal device, the time for a full re-orientation after voltage change, i.e. the relaxation period, may be assumed to be 50 ms. The signal generation time interval may be set, for instance, to 100 ms, i.e. double of the time the phase shifting means needs to perform a full phase shifting. Initially, the phase shift is 0 for the entire beam diameter 24. A first phase shifting from 0 to π may be triggered at the beginning of the signal generation time interval for the region encompassed by rectangle 24″ and for the region outside both rectangles 24′ and 24″. The arrows in FIG. 9b indicate that a phase shifting is triggered at the points of time denoted above the circles representing the beam diameter, while the values without arrows indicated instantaneous values representing the phase shifts reached by the liquid crystal molecules at that point of time. After 50% of the relaxation period, i.e. at 25 ms, a phase shifting from 0 to π is triggered for the region encompassed by rectangle 24′. This does not affect the liquid crystal molecules in the region 25 intersecting with rectangle 24″ as these molecules are already in the process of orienting towards n. After 100% of the relaxation period, i.e. at 50 ms, a counteracting phase shift is triggered for the disjoint region of rectangle 24″ and the region outside both rectangles. In the intersecting region 25, the phase shift has reached π and will remain there until the remaining part of rectangle 24′ has reached that value which is the case at three quarters of the relaxation period, i.e. at 75 ms. At this instant, a phase shifting from π to 0 will be triggered, but it will be only completed halfway when the signal generation time interval ends at 100 ms. As net effects, a full wash-out will be obtained for the disjoint region of rectangle 24″ and the region outside both rectangles, an almost full wash-out will be obtained for the disjoint region of rectangle 24′ and a slight wash-out, i.e. the highest fringe contrast, will be obtained for the region of interest 25.

The aforementioned modality of triggering phase shifting for one or more portions of the processing or reference beam during, preferably in the midst (50%), of the relaxation period associated with phase shifting for one or more other portions of the processing or reference beam can be generalised to other configurations of regions than the set of two rectangles. It is, of course, not limited to the setup of FIG. 9 but can be applied to all setups with phase shifting means having a sufficiently-defined relaxation period, as is the case especially with liquid crystal devices. Moreover, the signal generation time interval can be taken to be longer than twice the relaxation period, preferably an integer multiple of the relaxation period. Further, additional phase shiftings next to the first and second could also be applied.

FIG. 9c shows, as an example, how this modality with various phase shifts can be extended. The circumference of the region of interest 25 is covered with 13 regions 24.1 to 24.13 which are circular in this example. If only one (instead of 13) phase shifting means is used, subsequent phase shifts may be applied to the beam portions covered by the region 25 plus region 24.1, then region 25 plus region 24.2, then region 25 plus 24.3 etc. so that the liquid crystal molecules associated with region 25 do not find the time to substantially re-orient. Likewise, the subsequent phase shifts may only be applied to the regions 24.1, 24.2, 24.3 etc. The remaining region 26 outside the region 25 and 24.1, 24.2, 24.3 etc. may be included in this scheme so that a full wash-out is effected for this region 26.

This general modality of performing more than one phase shiftings is not limited to the particular setup shown in FIG. 9. It may be performed with all setups using the invention, both with a plurality of phase shifting means or with only one phase shifting means with which the plurality of phase shiftings are subsequently performed.

FIG. 10 shows another setup with bulk optics. The reflective phase shifting means 4′ is slightly beveled (not shown) and no pinhole is used. Consequently, next to the 1^{st} order (dotdashed line), the 0^{th} order (solid line) is reflected and collimated by lens system 3. An additional mirror 10′ reflects the 0^{th} order to the detector 13 where both orders interfere, i.e. the second order is used as the reference beam. As the application may require, an optical delay line can be inserted in the path of the 0^{th} order. It is also possible not to bevel the phase shifting means 4′ and to use the 0^{th} order as processing beam and the 1^{st} order as reference beam. The beam coming from mirror 10′ may be redirected by another mirror or a prism to optimise imaging by detector 13. In this setup, the phase shifting means 4′ acts as beam splitting means so that the beam splitting means is arranged for shifting the phase of a portion of the processing beam or the reference beam, and no extra device is needed.

FIG. 11 shows a setup in which the invention is utilised for communications. Again, the setup is based on a Mach-Zehnder interferometer configuration with bulk optics. Here again, an additional pinhole 6′ is used for blocking unwanted reflections. Reference 19 denotes a range in open space through which the optical communication shall take place.

The data to be communicated are encoded in the phase mask applied to the reflective phase shifting means 4′. For instance, five bit may be encoded in parallel as shown above in FIG. 4 (one bit in central position, one in top position, one right, one bottom and one left). The light beam modulated therewith is sent through the optical processing path with the open space section 19. The synchronisation signal and the reference beam are transmitted in parallel with the spatially phase modulated beam along synchronisation line S and the optical reference path, respectively. As mentioned above, the synchronisation line S can be a wireless connection, so the entire system can bridge distances without requiring a physical connection.

FIG. 12 shows the same setup as FIG. 11 with the exception that the open space section 19 has been replaced by an optical fibre 20 through which the spatially phase modulated light beam is sent. A multimode fibre should be used to ensure proper transmission of the phase modulated beam.

FIG. 13 shows a setup according to the invention used for communication. It is based on a Michelson interferometer configuration with a reflective phase shifting means in one arm. The synchronisation signal is converted into a light signal by a pulsed light source 21, acting as synchronising signal generation means, and fed by a beam combining device 22, e.g. a dichroic mirror, into the optical fibre 20 through which also the light beam carrying the data is sent. So only one physical connection is needed for the data transmission. The pulsed synchronisation signal triggers the acquisition time interval in the detector 13.

FIG. 14 shows a setup for use in communications in which a reflective phase shifting means 4′ acts as beam splitter. It is slightly beveled so that the solid line represents the 0^{th} order reflection while the dotdashed line represents the 1^{st} order, but the roles may be vice versa without beveling. Here again, a pulsed light source 21 provides the synchronisation signal.

1. Method of manipulating the interference fringe contrast in a beam of light comprising the steps of
generating a spatially coherent beam of light,
splitting said beam of light into a processing beam and a reference beam,
directing the processing beam into an optical processing path,
directing the reference beam into an optical reference path,
performing a first phase shifting for a portion of the processing beam or the reference beam,
generating at least one interferometric signal from the processing beam and the reference beam during a predetermined signal generation time interval, characterised in that
said first phase shifting is performed about a first predetermined phase shift after a first predetermined period within the signal generation time interval.

2. Method according to claim 1, characterised by the step of performing a second phase shifting for an associated portion of the processing beam or the reference beam about a second predetermined phase shift within the signal generation time interval.

3. Method according to any of the preceding claims, characterised by the steps of
generating a plurality of interferometric signals from the processing beam and the reference beam during predetermined signal generation time intervals, whereas each generation time interval is associated with one of the signals, and
performing said first phase shifting, and optionally second phase shifting, separately for each portion of a plurality of portions of the processing beam and/or the reference beam about predetermined first, and optionally second, phase shifts after first, and optionally second, predetermined portions of the signal generation time intervals, whereas each of the phase shifted beam portions is associated with one of the interferometric signals.

4. Method according to claim 3, characterised in that the plurality of portions with which phase shiftings are performed comprise a set of portions which are at least partially disjoint, whereas the disjoint regions are distributed along a circumference.

5. Method according to any of the preceding claims, characterised by the step of placing a sample (9) to be investigated into the optical processing path.

6. Method according to any of the preceding claims 3 to 4, characterised by the step of said first phase shifting is performed for the plurality of portions of the processing beam and/or the reference beam in dependence of digital data.

7. Method according to any of the preceding claims, characterised in that said beam splitting and said first, and/or optionally second, phase shifting are performed as one step.

8. Method according to any of the claims 6 to 7, characterised by the steps of
recombining the processing beam and the reference beam after said first, and optionally second, phase shifting,
directing the recombined beam into an optical communications path before generating said at least one interferometric signal,
sending a synchronising light beam through said optical communications path.

9. Apparatus for manipulating the interference fringe contrast in a beam of light comprising a light source (1) arranged for generating a spatially coherent beam of light, beam splitting means (2) arranged for splitting said beam of light into a processing beam and a reference beam and for directing the processing beam into an optical processing path and further for directing the reference beam of light into an optical reference optical path, phase shifting means (4, 4′, 4″) arranged for shifting the phase of a portion of the processing beam or the reference beam, sensor means (13) arranged for generating at least one interferometric signal from the processing beam and the reference beam during a predetermined signal generation time interval, characterised in that said phase shifting means (4, 4′, 4″) comprises synchronising means (S) arranged for triggering a first phase shifting about a first predetermined phase shift after a first predetermined period within the signal generation time interval.

10. Apparatus according to claim 9, characterised in that said synchronising means (11) is further arranged for triggering a second phase shifting for an associated portion of the processing beam or the reference beam about a second predetermined phase shift within the signal generation time interval.

11. Apparatus according to any of the claims 9 to 10, characterised in that said sensor means (13) is arranged for generating a plurality of interferometric signals from the processing beam and the reference beam during predetermined signal generation time intervals, whereas each generation time interval is associated with one of the signals, and said phase shifting means (4, 4′, 4″) is arranged for shifting the phases separately for each portion of a plurality of portions of the processing beam and/or the reference beam about predetermined first, and optionally second, phase shifts after first, and optionally second, predetermined portions of the signal generation time intervals, whereas each of the phase shifted beam portions is associated with one of the interferometric signals.

12. Apparatus according to claim 11, characterised in that the plurality of portions with which phase shiftings are performed comprise a set of portions which are at least partially disjoint, whereas the disjoint regions are distributed along a circumference.

13. Apparatus according to any of the claims 9 to 12, characterised in that it further comprises sample (9) mounting means (9′) located in the optical processing path.

14. Apparatus according to claim 13, characterised in that it further comprises scanning means (8) located in the processing path arranged for scanning the processing beam over a sample position in said sample mounting means (9′).

15. Apparatus according to any of the claims 11 to 12, characterised in that said phase shifting means (4, 4′, 4″) is arranged for shifting the phases separately for each portion of said plurality of portions of the processing beam and/or the reference beam in dependence of digital data.

16. Apparatus according to any of the claims 9 to 15, characterised in that said beam splitting means (2) is further arranged for shifting the phase of a portion of the processing beam or the reference beam.

17. Apparatus according to any of the claims 15 to 16, characterised in that it further comprises recombining means (22) arranged for recombining the processing beam and the reference beam and for directing the recombined beam into an optical communications path, synchronising signal generation means (21) arranged for sending a synchronising light beam through said optical communications path.
